(19) United States
(12) Patent Application Publication
(10) Pub. No.: US 2009/0313545 A1
(43) Pub. Date: Dec. 17, 2009

(54) METHOD AND APPARATUS FOR PLAYING MEDIA FILE

(75) Inventors: Hee Woon KIM, Suwon-si (KR); Jae Joon HWANG, Seoul (KR); Yu Ran KIM, Yongin-si (KR); Young Sun SHIN, Seongnam-si (KR); Jin Yong KIM, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/478,403

(22) Filed: Jun. 4, 2009

(30) Foreign Application Priority Data
Jun. 17, 2008 (KR) 10-2008-0057052

(51) Int. Cl. G06F 3/01

(52) U.S. Cl. 715/720; 715/723

(57) ABSTRACT

An apparatus and method for playing media files are disclosed. The playback method includes: receiving a user option request from a user; selecting, according to a user input, a frame of the media file to process the received user option request; moving to the selected frame when the user option request requires a frame shift; and playing back the media file from the selected frame in response to a playback request.

### CROSS REFERENCE TO RELATED APPLICATION

This application claims priority from and the benefit of Korean Patent Application No. 10-2008-0057052, filed on Jun. 17, 2008, which is hereby incorporated by reference for all purposes as if fully set forth herein.

### BACKGROUND OF THE INVENTION

1. Field of the Invention

The present invention relates generally to playback of media files and, more particularly, to a method and apparatus for playing media files with enhanced user convenience.

2. Description of the Background

Availability of high-end devices due to rapid advances in technologies has stimulated interest in developing mobile devices having user-friendly features beyond implementation of simple functions. To satisfy user needs, advanced mobile devices may have various functions related to playback of music files, playback of video files, shooting of videos, electronic mailing, and access to content providing networks, such as the Internet, for various contents. For functions related to, for example, playback of music files, shooting of videos, and electronic mailing, user friendliness may be important. For example, during file playback, when the user wants to skip the current portion being played and jump backward or forward to another portion, the user may use keys such as ‘fast forward’ or ‘rewind’ to find the desired portion. Here, the user may find the desired portion with single or multiple key manipulations.

Further, devices with touch screens have become popular. A touch screen can act as both an input unit and display unit, and it can receive an input by sensing a touch on the screen, not by a key press. Some users prefer to utilize touch screens because of their visual appeal and ease of use. Visualization is important for using various contents with touch screens. For example, in displaying a list of files, utilizing images representing files may be preferred to simply listing filenames. Further, for user convenience, when a file is selected, the image associated with the selected file may change shape to indicate the selection. Along with technical advances, however, user-friendly features are very desirable.

### SUMMARY OF THE INVENTION

Exemplary embodiments of the present invention provide a method and apparatus for playing a media file.

Exemplary embodiments of the present invention also provide a method and apparatus for playing a media file according to user options in a device having a touch screen.

Additional features of the invention will be set forth in the description which follows, and in part will be apparent from the description, or may be learned by practice of the invention.

An exemplary embodiment of the present invention discloses a playback method of a media file composed of multiple frames. The method includes detecting a user option request; selecting, in response to a user input, one frame of the multiple frames of the media file to process the detected user option request; moving to the selected frame when the user option request requires a frame shift; and playing back the media file from the selected frame in response to a playback request.

Another exemplary embodiment of the present invention discloses a media file playback apparatus, including: a storage unit to store at least one media file composed of multiple frames, and to store selected frames during processing of a user option; an input section to receive a user input for a user option request and for selection of a frame or image; a display section to display an image associated with a frame, and to display a requested user option; and a control unit to receive the user option request, to select, in response to a user input, one frame of the multiple frames of the media file to process the received user option request, to move to the selected frame when the user option request requires a frame shift, and to play back the media file from the selected frame in response to a playback request.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a media player according to an exemplary embodiment of the present invention.

FIG. 2 is a flow chart showing a method of playing a media file with user options according to an exemplary embodiment of the present invention.

FIG. 3 shows screen representations related to initiation of playing a media file.

FIG. 4A and FIG. 4B are flow charts for processing user options according to option types according to an exemplary embodiment of the present invention.

FIG. 5, FIG. 6, FIG. 7A, FIG. 7B, FIG. 7C, FIG. 8, FIG. 9, FIG. 10, and FIG. 11 are screen representations related to processing of user options according to exemplary embodiments of the present invention.

FIG. 12 is additional screen representations related to processing of user options according to an exemplary embodiment of the present invention.

### DETAILED DESCRIPTION OF THE ILLUSTRATED EMBODIMENTS

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

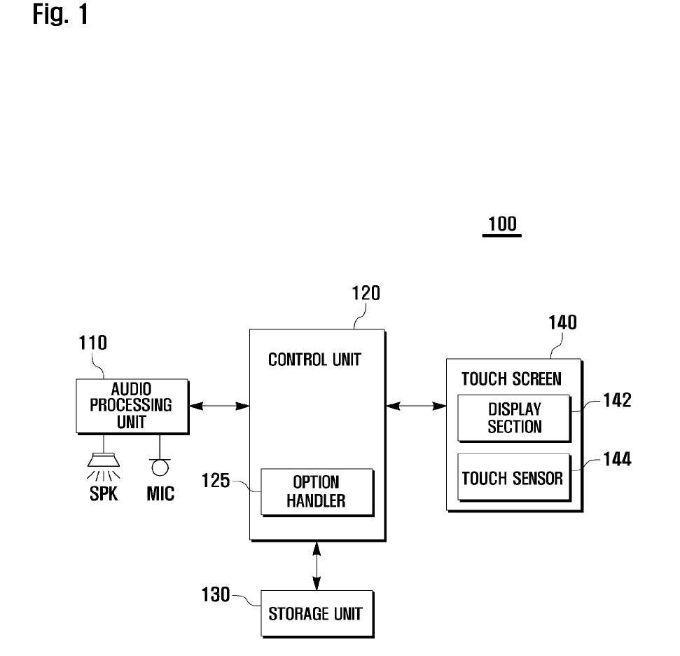

FIG. 1 is a block diagram of a media player 100 according to an exemplary embodiment of the present invention. The media player 100 is a device equipped with a module that plays back media files such as a music file, video file, still image file, and moving image file. For example, media player 100 may be a smart player having a microprocessor. Examples of the media player 100 include a personal digital assistant (PDA), laptop computer, portable multimedia player (PMP), and a mobile communication terminal that has a media playing module, like a smart phone. Hereinafter, a file playing device having a touch screen is described as the media player 100. However, a file playing device without a touch screen can also be used as media player 100.

Referring to FIG. 1, an audio processing unit 110 reproduces various audio signals from a control unit 120 through a speaker SPK, and sends an audio signal from a microphone MIC to the control unit 120.

The control unit 120 controls the overall operation of the media player 100. To play back files, the control unit 120 can include a data coder/decoder (codec) to process packet data and an audio codec to process audio data. Further, in response to a user option request, the control unit 120 processes the requested user option. In response to a selection input during user option processing, the control unit 120 may select one frame of multiple frames constituting a file and moves to the selected frame to play back the selected frame and its subsequent frames, or resumes playing back the frame paused due to handling of the requested user option and its subsequent frames, depending upon the requested user option. The control unit 120 can include an option handler 125 to process user options. Here, user options may include ‘Add to My Best Scene’, ‘View My Best Scene’, ‘Change Thumbnail’, ‘Chapter View’, ‘Add Text Bookmark’, ‘View Bookmarks’, ‘Info’, and ‘Zoom’.

A storage unit 130 includes a program storage section and data storage section. The program storage section can store programs for controlling operations of the media player 100. The data storage section can temporarily store data generated from execution of programs, and store data received from the outside. The data storage section stores media files, as well as images and information on files selected by the user during user option processing.

A touch screen 140 can include a display section 142 and a touch sensor 144, which acts as an input means. The display section 142 displays the status of the media player 100. The display section 142 may include one or more liquid crystal display (LCD) devices, an LCD controller, and memory for storing display data. The display section 142 displays operation states of the media player 100 and various information in the form of a text, image, animation, or icon. The touch sensor 144 can be installed at the display section 142, and it can include a touch sensing module (not shown) for sensing an input event by detecting a change in a physical quantity (for example, resistance or electrostatic capacity) of the touch screen 140 caused by a user operation, and a signal output module (not shown) for generating a digital signal corresponding to the physical quantity change caused by the input event. The signal output module determines whether an input event associated with a physical quantity change is a touch event or a drag event, and obtains the coordinates of the position at which a detected input event occurs.

Next, configuration and processing of user options are described in detail with reference to the drawings. For the purpose of description, processing of user options related to playback of moving image files is described. However, it is also possible to process user options related to other types of media files. For moving image files, user options can include: an ‘Add to My Best Scene’ option for adding selected frames of a moving image file to a preferred image list; a ‘View My Best Scene’ option for displaying the preferred image list, selecting an image from the list, jumping to a frame associated with the selected image, and playing the frame and its subsequent frames; a ‘Chapter View’ option for demarcating a moving image file into segments of a fixed size, displaying images associated with the beginning frames of the individual segments, and playing back a selected frame; an ‘Add Text Bookmark’ option for inserting text into a selected frame of a moving image file as a bookmark and adding the bookmark to a bookmark list; a ‘View Bookmarks’ option for displaying the bookmark list; a ‘Zoom’ option for enlarging or reducing a selected image of a moving image file, and displaying the enlarged or reduced image; a ‘Change Thumbnail’ option for changing, when moving image files are represented by thumbnail images, the thumbnail image of a selected moving image; and an ‘Info’ option for displaying information on moving image files. Additional options may be defined for user convenience.

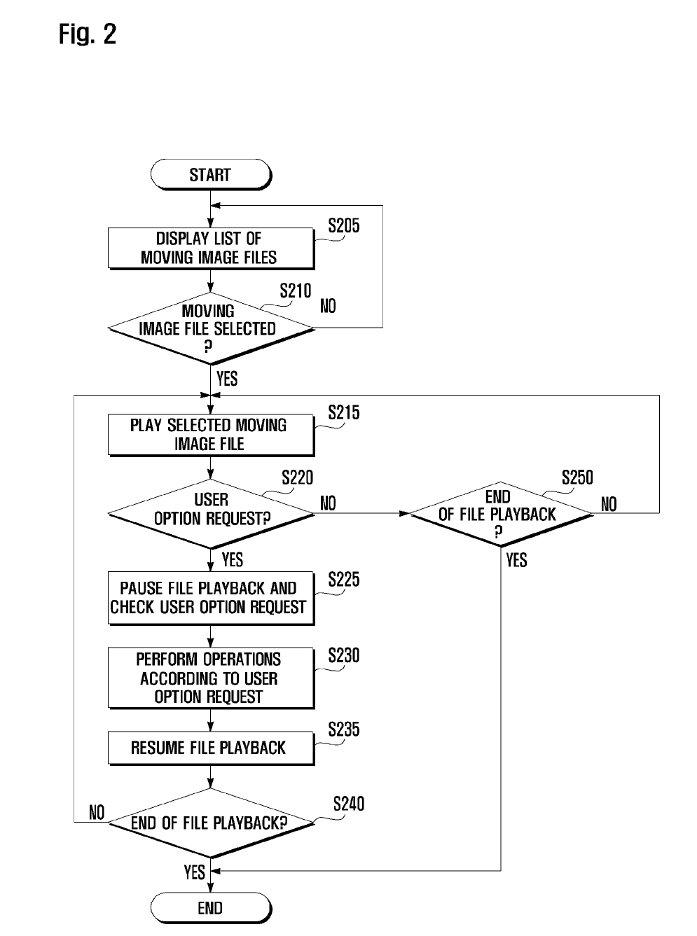

FIG. 2 is a flow chart showing a method of playing a media file with user options according to an exemplary embodiment of the present invention.

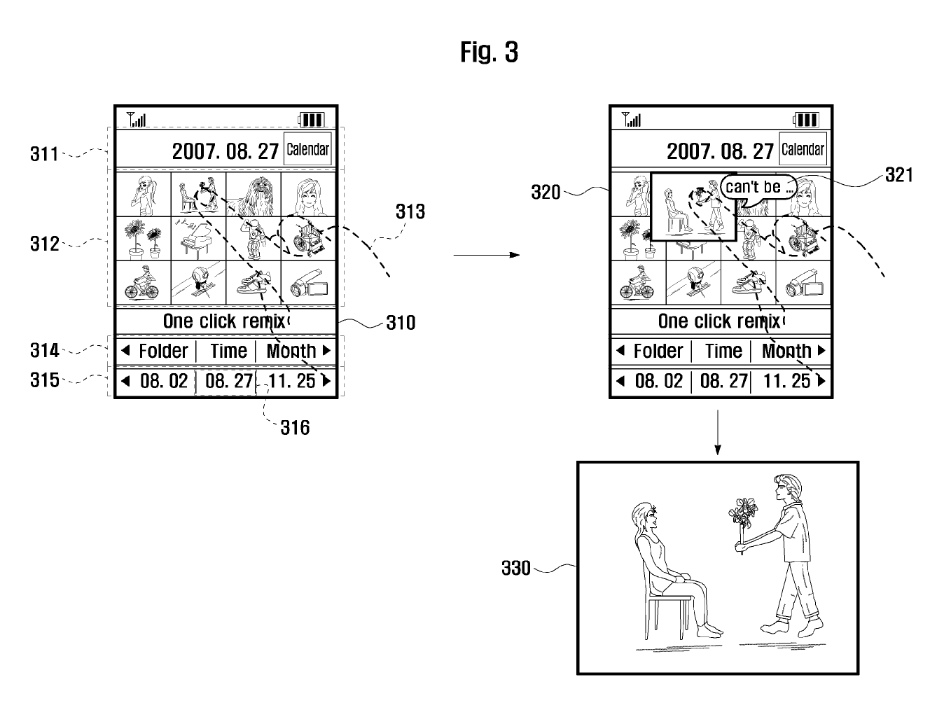

Referring to FIG. 2, in response to a user request, the control unit 120 of the media player 100 displays a list of moving image files on the display section 142 (S205). Media file playing with user options according to exemplary embodiments of the present invention can be referred to as ‘smart play’. Smart play can be initiated through various methods, such as a file manager managing media files, a media gate providing a list of media files, and an album having a list of media files. Media file selection and playback through the media gate is described in detail in connection with FIG. 3.

FIG. 3 shows screen representations related to initiation of playing a media file. Moving image files may be categorized according to given attributes and contained in corresponding folders. When a folder is selected, moving image files in the selected folder can be listed, as screen 310 shows in FIG. 3. A higher folder region 314 of the screen 310 is used to list high level items (folders), and a lower folder region 315 is used to list lower level items (folders) of a selected high level item (folder). The user can use arrows displayed in the higher folder region 314 and lower folder region 315 to navigate between high level and low level folders for selecting a folder containing a desired moving image file. In the screen 310, a high level folder ‘Date’ (high folder region 314) and a low level folder ‘08.27’ (2007/08/27, low folder region 315) are selected, and images associated with moving image files in the folder ‘08.27’ are displayed in a file display region 312. In FIG. 3, while folders are categorized according to the ‘time’ attribute, they may also be categorized according to another attribute such as location, producer, or object name. The name of the selected folder (folder ‘2007.08.27’) is displayed in a selected folder region 311, and images associated with moving image files in the folder ‘2007.08.27’ are displayed in the file display region 312. Moving image files can be listed using filenames alone, using thumbnail images enrolled for representing moving image files, or using other means. In FIG. 3, moving image files are listed using enrolled thumbnail images. In exemplary embodiments of the present invention, the media player 100 has the touch screen 140 that senses a touch as an input event, and plays a moving image file associated with a thumbnail image being displayed that is touched by the finger 313 of the user. To be more specific, referring to screen 320, when a thumbnail image is touched by the finger 313, the title of a moving image file associated with the touched thumbnail image can be displayed as a word balloon 321. After the touch, the moving image file associated with the touched thumbnail image is selected and played back as illustrated by screen 330.

Referring back to FIG. 2, the control unit 120 determines whether one of the listed moving image files is selected (S210). Selection of a file can be made by a user input through an input means. As described above in connection with the screen 320 of FIG. 3, when a file is tapped with the finger 313, the control unit 120 regards the tapped file as being selected. If a moving image file is selected, the control unit 120 proceeds to step S215. If no moving image file is selected, the control unit 120 returns to step S205 to list moving image files for selection. At step S215, the control unit 120 plays back the selected moving image file as shown by the screen 330 in FIG. 3. During file playing, the control unit 120 determines whether a user option request is received (S220). If a user option request is received, the control unit 120 proceeds to step S225. If no user option request is received, the control unit 120 determines whether playback of the file is completed (S250). If playback of the file is completed, the control unit 120 ends the process. If playback of the file is not completed, the control unit 120 returns to step S215. Here, user options can include ‘Add to My Best Scene’, ‘View My Best Scene’, ‘Chapter View’, ‘Add Text Bookmark’, ‘View Bookmarks’, ‘Zoom’, ‘Change Thumbnail’, and ‘Info’ options.

If a user option request is received, the control unit 120 pauses playback of the moving image file and checks the received user option request (S225). The control unit 120 performs an operation according to the received user option (S230). For example, if the received user option is ‘Add to My Best Scene’, an operation is carried out to add an image selected by the user to the preferred image list. If the received user option is ‘View My Best Scene’, an operation is carried out to display images in the preferred image list. Processing of user options is described below in more detail with reference to the drawings. After performing the operations at S230, the control unit 120 may then resume playing back the paused moving image file (S235). Here, the playback resumption point may be different for different user options. For example, if the received user option is an option not requiring a frame shift such as ‘Add to My Best Scene’ or ‘Add Text Bookmark’, the playback resumption point is the frame being played at the time of pause. If the received user option is an option requiring a frame shift such as ‘View My Best Scene’, ‘View Bookmarks’ or ‘Chapter View’, the playback resumption point is the frame selected during processing of the received user option. Thereafter, the control unit 120 checks whether playback of the moving image file is completed (S240). If playback of the file is completed, the control unit 120 ends the process. If playback of the file is not completed, the control unit 120 returns to step S215 for continued playback. Next, processing of the user option request at step S230 is described in more detail.

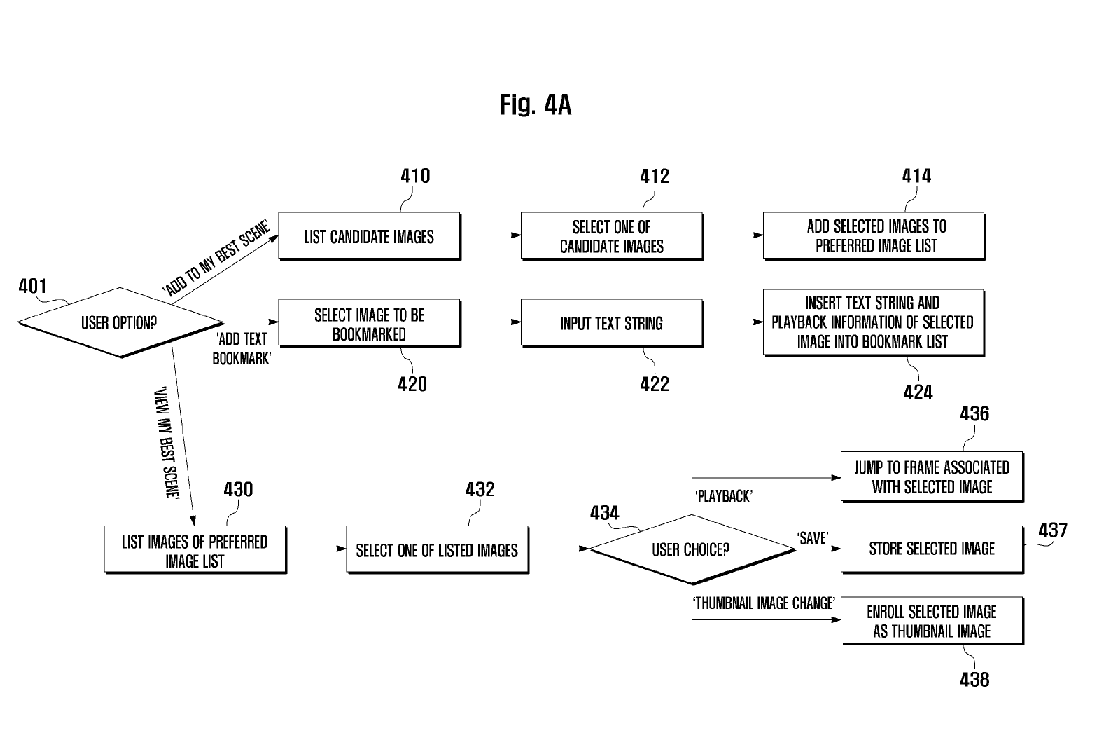

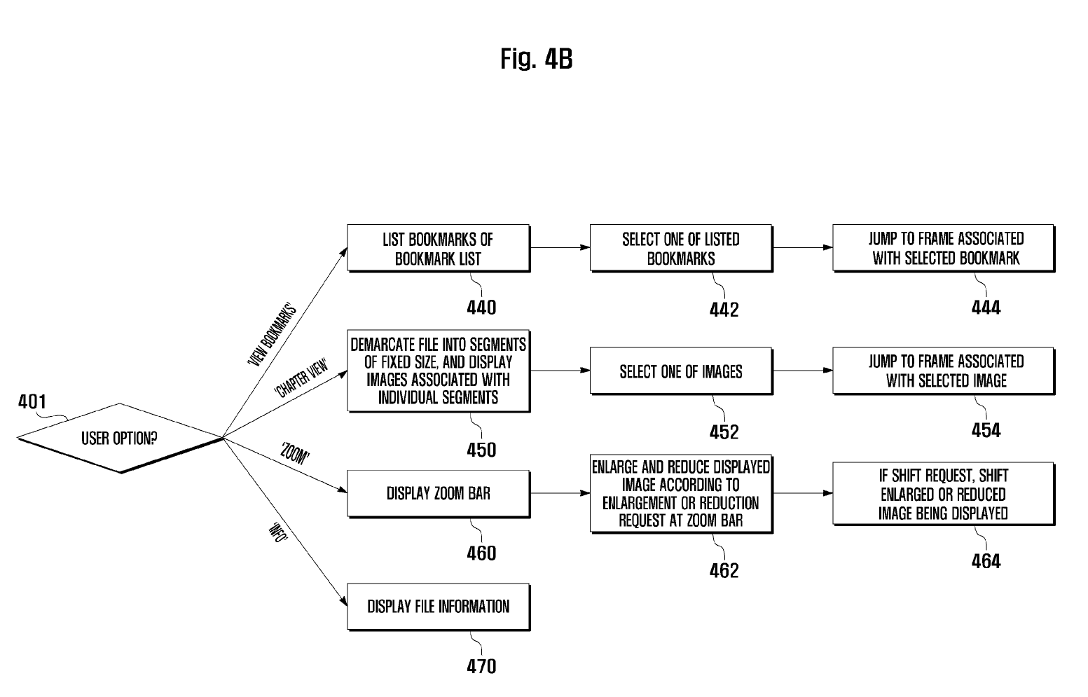

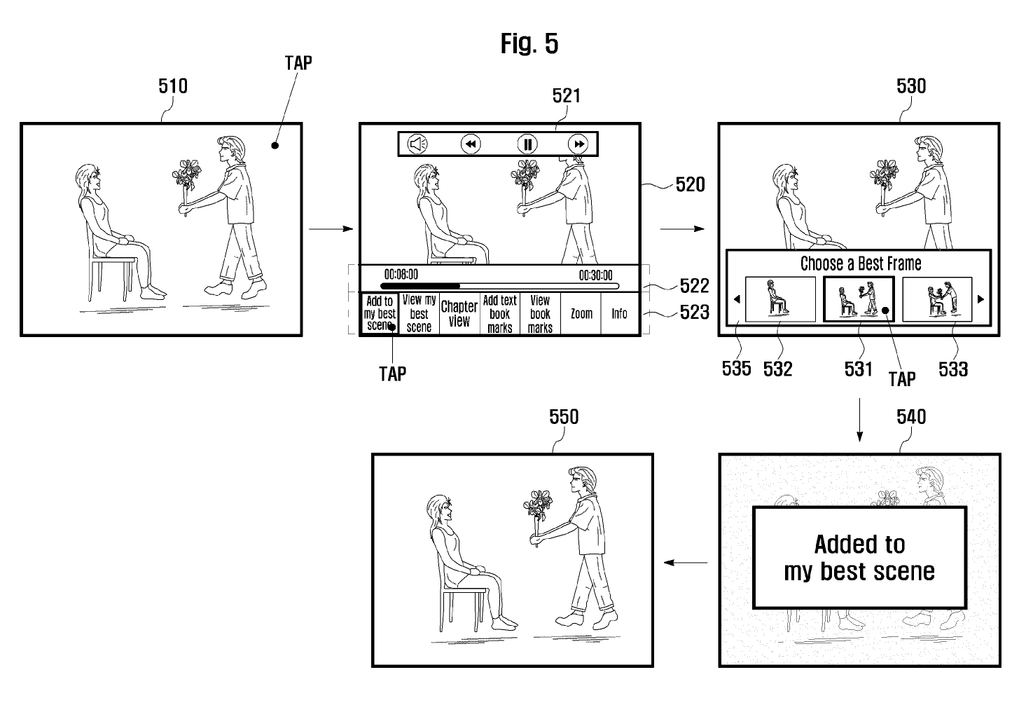

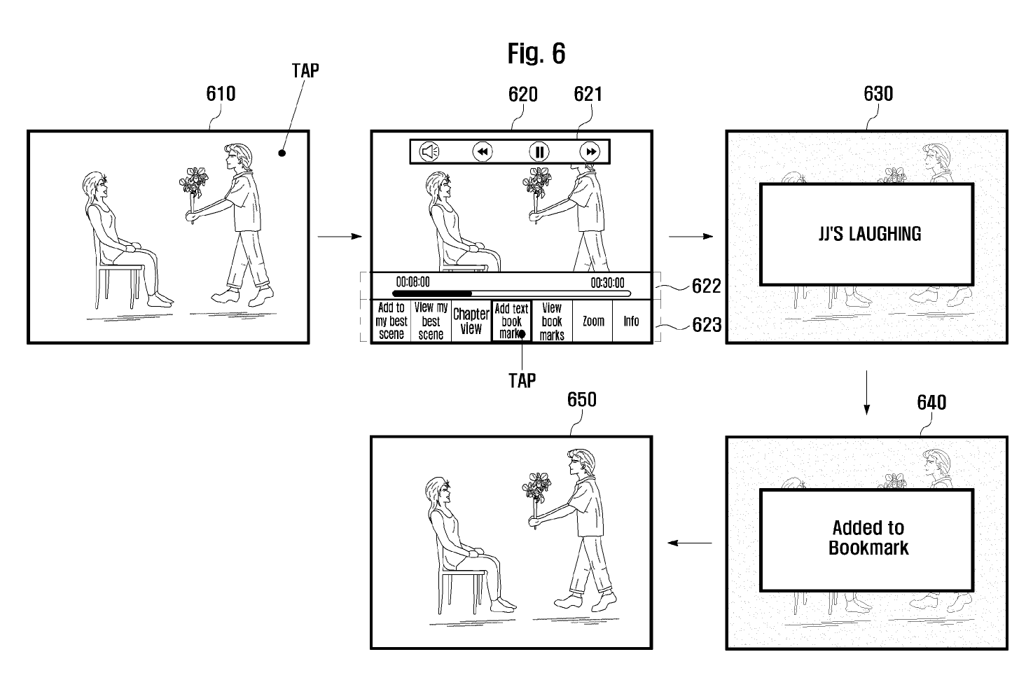

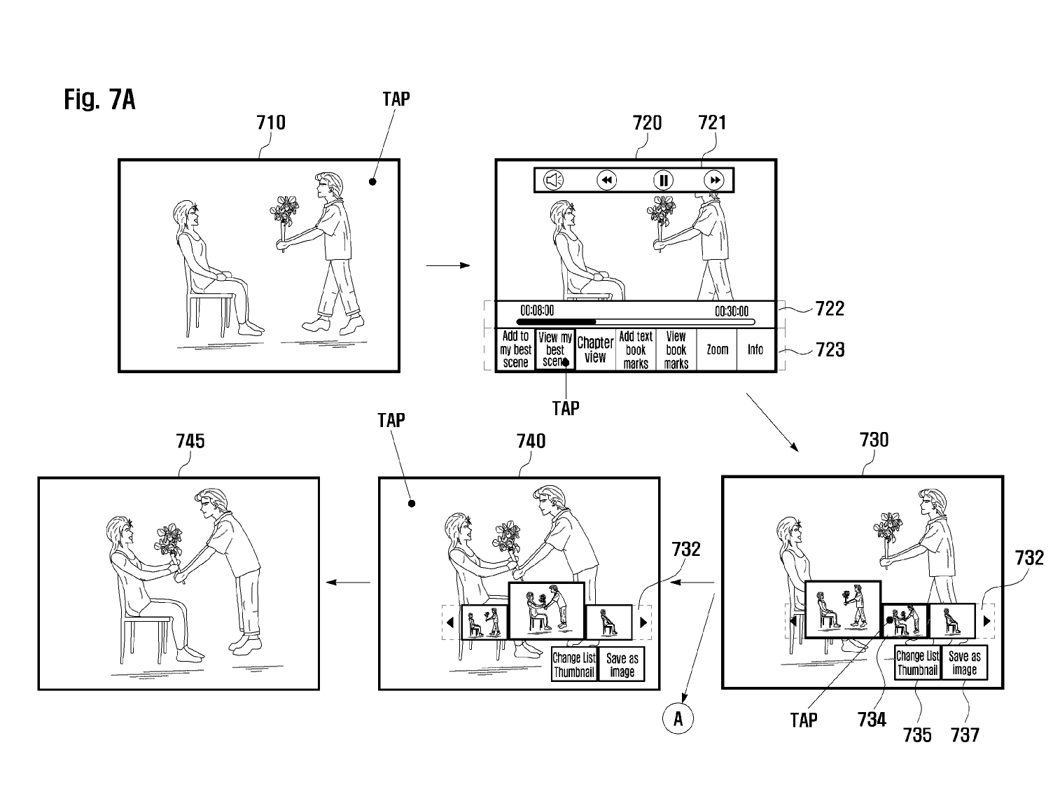

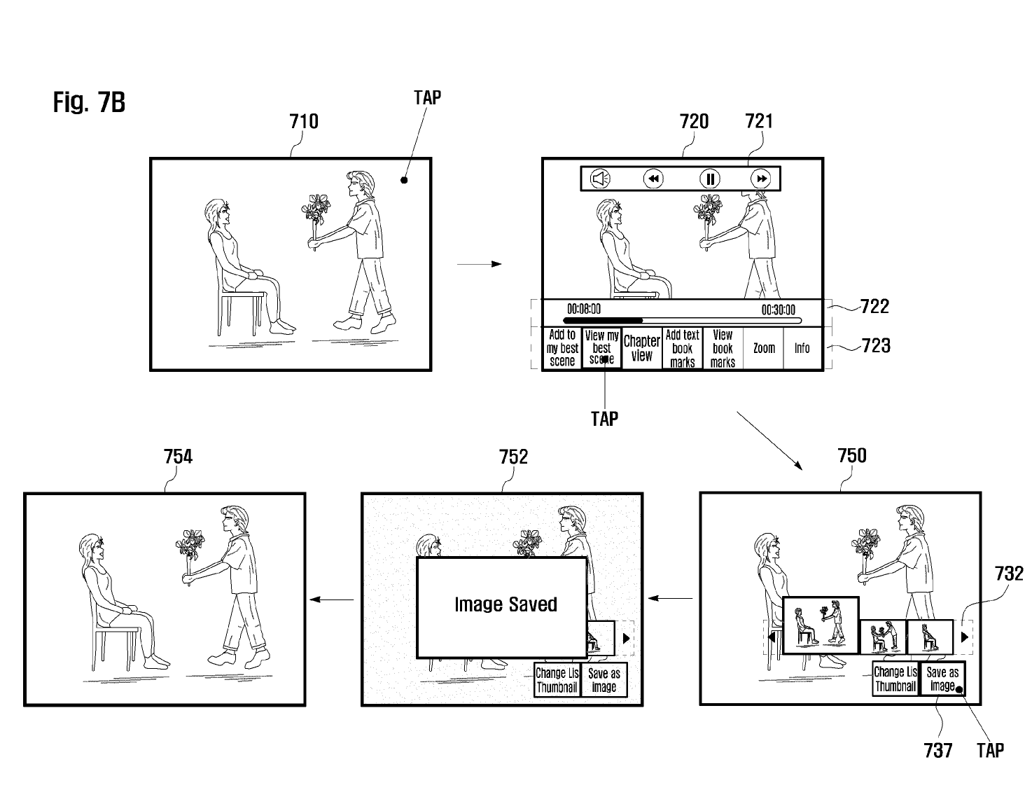

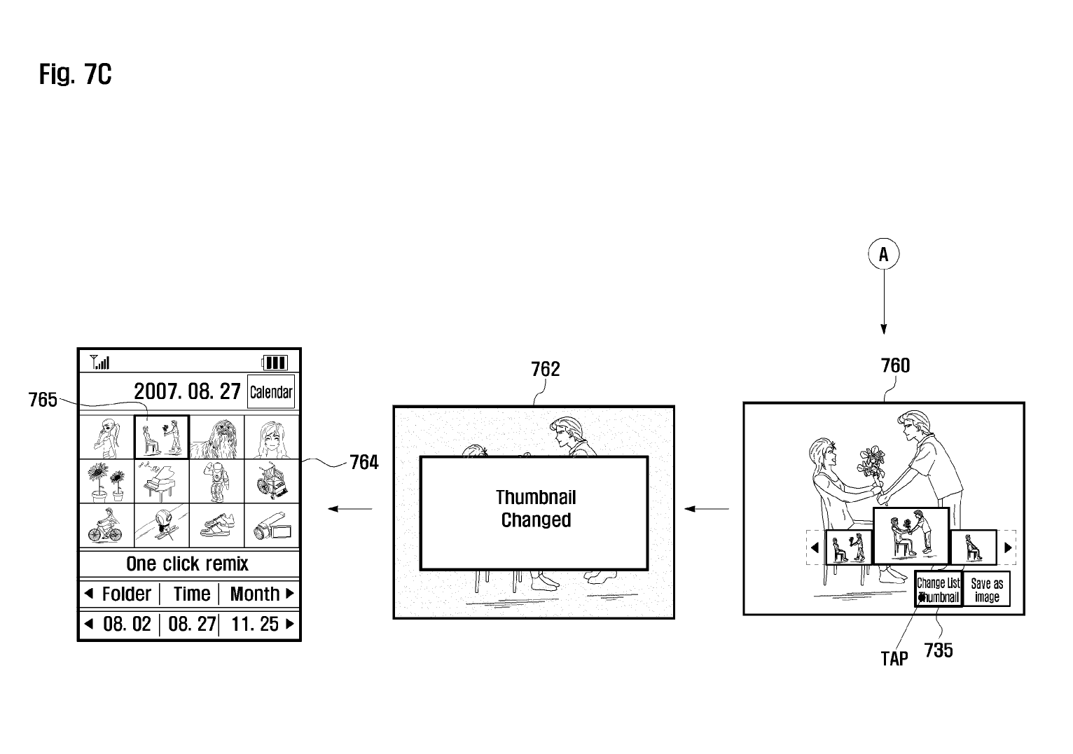

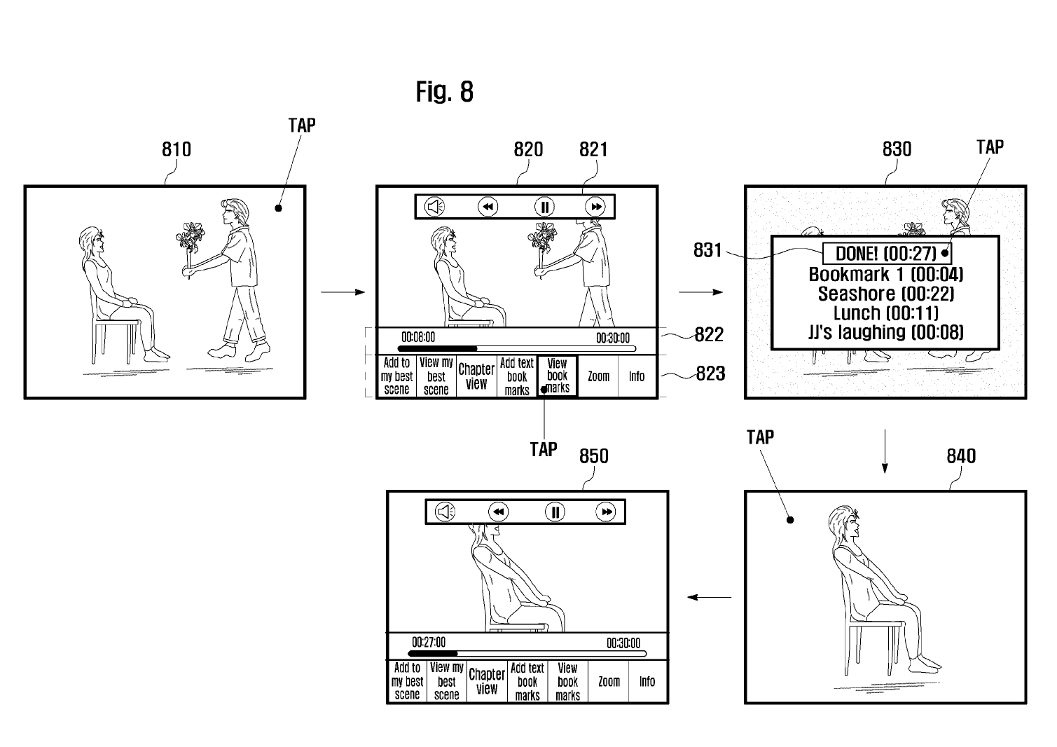

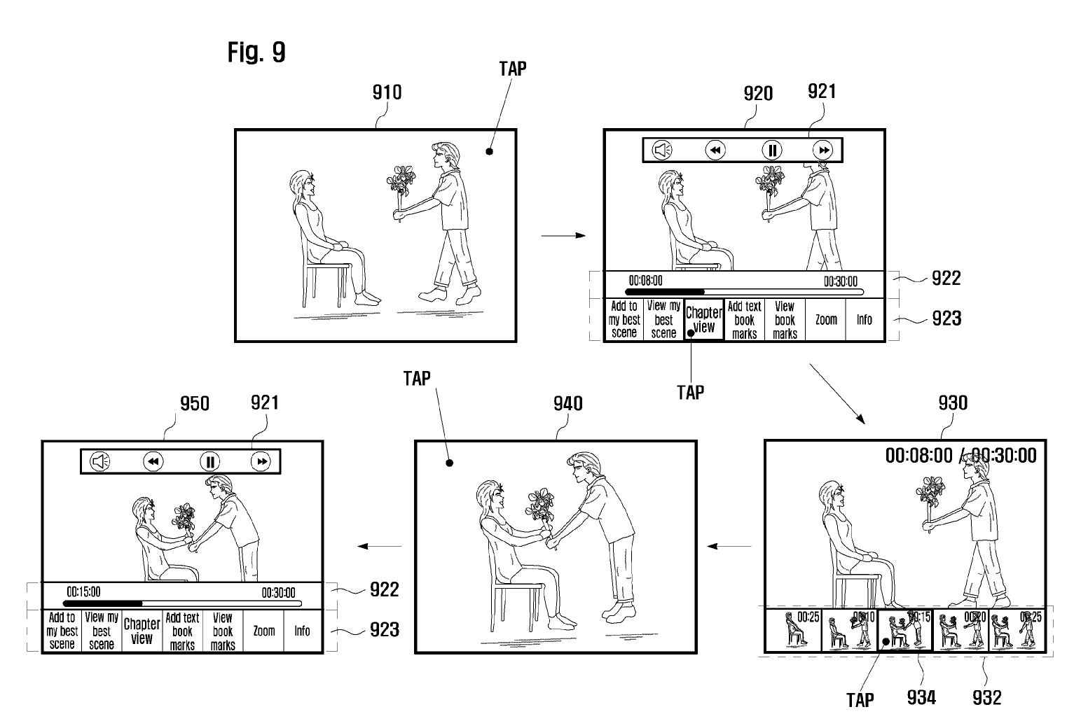

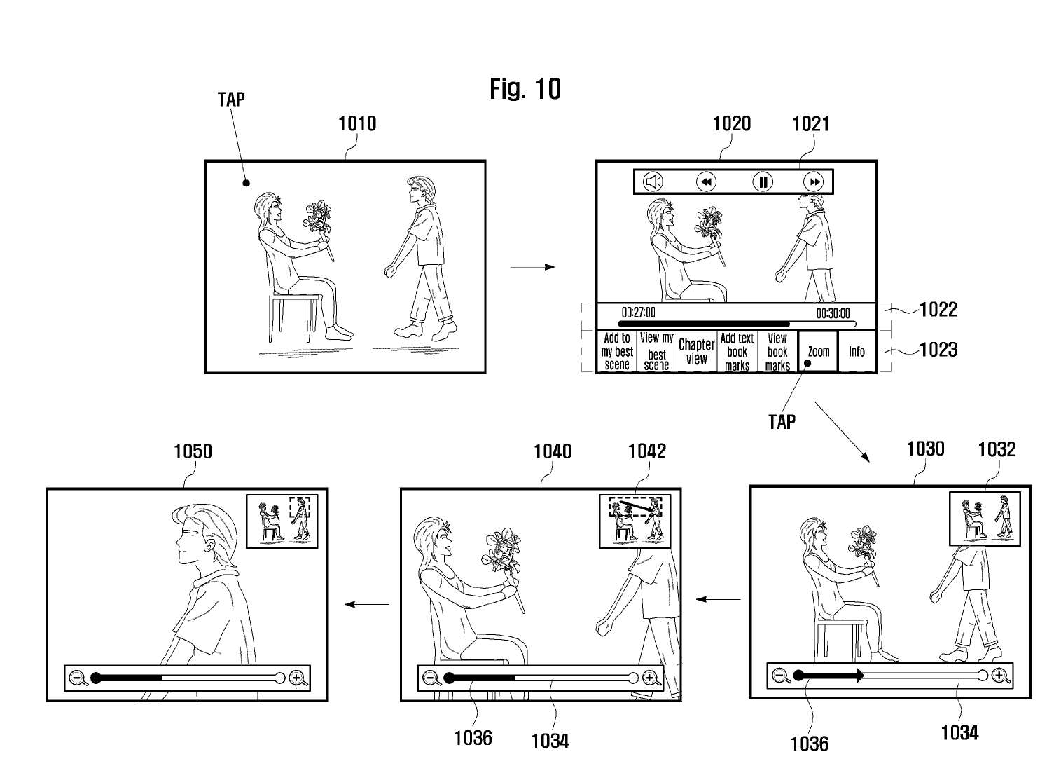

FIG. 4A and FIG. 4B are flow charts for processing user options according to option types. FIG. 5, FIG. 6, FIG. 7A, FIG. 7B, FIG. 7C, FIG. 8, FIG. 9, FIG. 10, and FIG. 11 are screen representations related to the user option processing of FIG. 4A and FIG. 4B.

Referring to FIGS. 4A, 4B, and 5 to 11, the control unit 120 examines the received user option (S401). If the received user option is ‘Add to My Best Scene’, the option handler 125 of the control unit 120 displays candidate images on the display section 142 so that one of the candidate images can be selected for being added to the preferred image list (S410). One or more images can be displayed as a candidate image on a given region of the display section 142. For example, in a moving image file, three candidate images may be the first frame being played at the time of receiving the ‘Add to My Best Scene’ request, the second frame immediately before the frame being played, and the third frame immediately after the frame being played. The option handler 125 selects one of the candidate images according to a selection input from the user (S412). As described in connection with FIG. 3, a selection input from the user may correspond to a tap on the touch screen 140. The option handler 125 adds the selected image to the preferred image list stored in the storage unit 130 (S414). Next, processing of the ‘Add to My Best Scene’ option is further detailed in connection with FIG. 5.

In FIG. 5, a selected moving image file is being played back on a screen 510, as in the case of the screen 330 in FIG. 3. During playback of the file, a finger tap on a portion of the screen 510 causes function bars 521, 522, and 523 to be displayed as an overlay on the screen as shown by a screen 520. These function bars 521, 522, and 523 include keys for invoking functions executable during playback of a moving image file. The function bar 521 may include, for example, selection keys for playback adjustment in relation to file listing, sound control, rewind, pause, and fast forward. The function bar 521 may further include other playback adjustment keys. The function bar 522 indicates the elapsed play time relative to the total play time of the file, and the function bar 523 includes keys to select user options. When a key of the function bars 521, 522, and 523 is selected, a function associated with the selected key is invoked. When the key of the function bar 523 associated with the ‘Add to My Best Scene’ option is selected by a tap on the screen 520, file playback is paused and a preset number of candidate images are displayed in a candidate image bar 535, as shown by a screen 530. The number of candidate images may be determined by the user or in the manufacturing process of the media player 100. Here, the number of candidate images is assumed to be three for the purpose of description, and the current image 531 corresponding to the frame being played at the time of selection of the ‘Add to My Best Scene’ option, the previous image 532, and the next image 533 corresponding respectively to the previous frame and the next frame, can be displayed in the candidate image bar 535. A left arrow in the candidate image bar 535 can be used to display images corresponding to the frames before that of the previous image 532, and a right arrow can be used to display images corresponding to the frames after that of the next image 533. That is, the left arrow and right arrow in the candidate image bar 535 enables the user to select a desired one of images corresponding to the frames of the file. When the current image 531 is selected by a user input among the images 531, 532, and 533 in the candidate image bar 535, the current image 531 is added to the preferred image list as shown by a screen 540, and file playback is resumed from the frame paused at the time of selection of the ‘Add to My Best Scene’ option, as shown by a screen 550.

Referring back to FIG. 4A, if the requested user option is ‘Add Text Bookmark’ at step S401, the option handler 125 of the control unit 120 selects an image to which a text bookmark is attached according to a user input and enters into text input mode to receive a text string to be inserted into a bookmark list (S420). The option handler 125 receives a text string from the user through an input means (S422). A text string may be input by a series of touches on the touch screen 140 that are sensed by the touch sensor 144. At the end of text input, the option handler 125 terminates text input mode and inserts playback information of the frame corresponding to the selected image and the received text string into the bookmark list (S424). Next, processing of the ‘Add Text Bookmark’ option is further detailed in connection with FIG. 6.

In FIG. 6, a selected moving image file is being played back on a screen 610, as in the case of the screen 330 in FIG. 3. As described before in connection with FIG. 5, during playback of the file, a finger tap on a portion of the screen 610 causes function bars 621, 622, and 623 to be displayed as an overlay on the screen, as shown by a screen 620. When a key of the function bar 623 associated with the option ‘Add Text Bookmark’ is selected by the user on the screen 620, text input mode is initiated, as shown by a screen 630. When the user inputs a text string “JJ's laughing” in text input mode, the option handler 125 adds the input text string to the bookmark list, as shown by a screen 640. When text input mode is initiated, input keys (not shown) can be displayed on the display section 142 to receive a text input. The bookmark list may take various forms. For example, an entry of the bookmark list can include the text string “JJ's laughing” and the elapsed play time at the time of selection of the ‘Add Text Bookmark’ option (‘00:08:00’ displayed at the function bar 622). When the text input ends, the option ‘Add Text Bookmark’ is terminated, and file playback is resumed from the frame paused at the time of selection of the ‘Add Text Bookmark’ option, as shown by a screen 650.

Referring back to FIG. 4A, if the requested user option is ‘View My Best Scene’ at step S401, the option handler 125 of the control unit 120 displays images of the preferred image list on the display section 142 (S430). The option handler 125 selects one of the displayed images according to a user selection (S432). Here, the displayed images may include only images of the preferred image list, or include a still image (on the display section 142) corresponding to the frame paused at the time of selection of the ‘View My Best Scene’ option, and images of the preferred image list as an overlay in a preferred image bar. When the preferred image list has a number of images greater than a preset number, the preset number of images are displayed in the preferred image bar and the remaining images can be displayed in the preferred image bar using left and right arrows. After one of the images displayed in the preferred image bar is selected, the option handler 125 prompts the user to choose one of ‘playback’, ‘thumbnail image change’, and ‘save as image’ (S434). If ‘playback’ is chosen, the option handler 125 jumps to the frame associated with the selected image and initiates playback from the associated frame (S436). If ‘save as image’ is chosen, the option handler 125 stores the selected image in the storage unit 130 (S437). If ‘thumbnail image change’ is chosen, the option handler 125 enrolls the selected image as the thumbnail image of the file (S438). Next, processing of the ‘View My Best Scene’ option is further detailed in connection with FIG. 7A, FIG. 7B, and FIG. 7C.

In FIG. 7A, a selected moving image file is being played back on a screen 710, as in the case of the screen 330 in FIG. 3. As described before in connection with FIG. 5, during playback of the file, a finger tap on a portion of the screen 710 causes function bars 721, 722, and 723 to be displayed as an overlay on the screen, as shown by a screen 720. When a key of the function bar 723 associated with the ‘View My Best Scene’ option is selected by the user on the screen 720, playback of the file is paused and images of the preferred image list are displayed on a preferred image bar 732, as shown by a screen 730. When the preferred image list has a number of images greater than a preset number, the preset number of images are displayed in the preferred image bar 732, and the remaining images can be displayed in the preferred image bar 732 using left and right arrows. When one of the images displayed in the preferred image bar 732 is selected with a tap, the selected image is displayed, as shown by a screen 740. A tap on a portion of the screen 740 results in a jump to the frame associated with the selected image, and playback is initiated from the associated frame, as shown by a screen 745. After one of the images displayed in the preferred image bar 732 is selected in the screen 730, selection of a ‘save as image’ option 737, as shown by a screen 750 of FIG. 7B, causes the selected image to be stored in the storage unit 130, as shown by a screen 752. Thereafter, file playback is resumed from the frame paused at the time of selection of the ‘View My Best Scene’ option as illustrated by a screen 754. After one of the images displayed in the preferred image bar 732 is selected in the screen 730, selection of a ‘thumbnail image change’ option 735, as shown by a screen 760 of FIG. 7C, causes the selected image to be stored in the storage unit 130 as a new thumbnail image of the file being played back, as shown by a screen 762. As shown by a screen 764 displaying a stored image file list, the stored image 765 is enrolled as a thumbnail image. Thereafter, file playback is resumed from the frame paused at the time of selection of the ‘View My Best Scene’ option.

Referring back to FIG. 4B, if the requested user option is ‘View Bookmarks’ at step S401, the option handler 125 of the control unit 120 displays bookmarks of the bookmark list on the display section 142 (S440). Bookmarks in the bookmark list may be represented in various ways, and it is assumed in this embodiment that a bookmark is displayed as a text given to the bookmark together with play time information of the associated frame. The option handler 125 selects one of the displayed bookmarks according to a user selection (S442). The option handler 125 makes a jump to the frame associated with the selected bookmark, and initiates playback from the associated frame (S444). Next, processing of the ‘View Bookmarks’ option is further detailed in connection with FIG. 8.

In FIG. 8, a selected moving image file is being played back on a screen 810, as in the case of the screen 330 in FIG. 3. As described before in connection with FIG. 5, during playback of the file, a finger tap on a portion of the screen 810 causes function bars 821, 822, and 823 to be displayed as an overlay on the screen, as shown by a screen 820. When a key of the function bar 823 associated with the ‘View Bookmarks’ option is selected by the user on the screen 820, playback of the file is paused, and bookmarks of the bookmark list are displayed, as shown by a screen 830. When the bookmark list has too many bookmarks to be displayed at once, up and down arrows (not shown) can be used to move between bookmarks. A finger tap can cause, for example, a bookmark ‘DONE! (00:27)’ to be selected, as shown by the screen 830. Upon selection of the bookmark ‘DONE! (00:27)’, the option handler 125 makes a jump to the frame corresponding to the play time (27 minutes) of the bookmark and displays an image associated with the corresponding frame, as shown by a screen 840. A tap on a portion of the screen 840 initiates playback from the corresponding frame, as shown by a screen 850. At the same time, the function bars 821, 822, and 823 may be displayed on the screen 850.

Referring back to FIG. 4B, if the requested user option is ‘Chapter View’ at step S401, the option handler 125 of the control unit 120 demarcates the moving image file into segments of a fixed size, and displays images associated with the beginning frames of the individual segments on a portion of the display section 142 (S450). The option handler 125 selects one of the displayed images according to user input (S452). On the display section 142, the image associated with the frame being played at the time of selection of the ‘Chapter View’ option is displayed, and images associated with the beginning frames of the segments are also displayed as an overlay on a segment image bar. When the images associated with the beginning frames are too many to be displayed at once, left and right arrows of the segment image bar can be used to move between the associated images. The option handler 125 makes a jump to the frame associated with the selected image, and initiates playback from the associated frame (S454). Next, processing of the ‘Chapter View’ option is further detailed in connection with FIG. 9.

In FIG. 9, a selected moving image file is being played back on a screen 910, as in the case of the screen 330 in FIG. 3. As described before in connection with FIG. 5, during playback of the file, a finger tap on a portion of the screen 910 causes function bars 921, 922, and 923 to be displayed as an overlay on the screen, as shown by a screen 920. When a key of the function bar 923 associated with the ‘Chapter View’ option is selected by the user on the screen 920, playback of the file is paused, and images associated with the beginning frames of the demarcated segments are displayed on a segment image bar 932. The number of images displayable at once on the segment image bar 932 is restricted. For example, as shown by a screen 930, if the number of images displayable at once on the segment image bar 932 is five and the number of images associated with the beginning frames is eight, five single images associated with the beginning frames can be displayed at once, and left and right arrows (not shown) can be used to display the remaining three images on the segment image bar 932. When one of the images displayed on the segment image bar 932 is selected with a tap, a jump is made to the frame associated with the selected image, and the selected image is displayed as shown by a screen 940. A tap on a portion of the screen 940 initiates playback from the associated frame, as shown by a screen 950. At the same time, the function bars 921, 922, and 923 may be displayed on the screen 950.

Referring back to FIG. 4B, if the requested user option is ‘Zoom’ at step S401, the option handler 125 of the control unit 120 displays a zoom bar on a portion of the display section 142 (S460). The zoom bar may be displayed on the display section 142 while file playback is being paused or continued. The option handler 125 identifies an enlargement value or reduction value by detecting a user movement on the zoom bar, and displays on the display section 142 an enlarged or reduced image corresponding to the enlargement value or reduction value (S462). The option handler 125 identifies a shift value for shifting the position of the enlarged or reduced image, and displays the enlarged or reduced image at a location corresponding to the shift value (S464). When the user issues a termination request for the ‘Zoom’ option at any one of steps S460 to S464, the ‘Zoom’ option is terminated and file playback is resumed. The playback is initiated at the frame associated with a selected image for shifting. Next, processing of the ‘Zoom’ option is further detailed in connection with FIG. 10.

In FIG. 10, a selected moving image file is being played back on a screen 1010, as in the case of the screen 330 in FIG. 3. As described before in connection with FIG. 5, during playback of the file, a finger tap on a portion of the screen 1010 causes function bars 1021, 1022, and 1023 to be displayed as an overlay on the screen, as shown by a screen 1020. When a key of the function bar 1023 associated with the ‘Zoom’ option is selected by the user on the screen 1020, a zoom bar 1034 is displayed, as shown by a screen 1030. An original image 1032 without enlargement or reduction can be displayed on the screen 1030. A slide bar 1036 on the zoom bar 1034 may be used to enlarge or reduce a displayed image, and an enlarged image is displayed as shown by a screen 1040 according to movement of the slide bar 1036 for enlargement. A shift action taken in the original image 1032 is indicated in an image 1042, and the currently displayed image is shifted according to the corresponding shift value, as shown by a screen 1050.

Referring back to FIG. 4B, if the requested user option is ‘Info’ at step S401, the option handler 125 of the control unit 120 displays file information on the display section 142 (S470). The file information is stored in the storage unit 130, and may include such information as filenames, file sizes, file types, and the like. When the user issues a termination request for the ‘Info’ option (like ‘back’), the ‘Info’ option is terminated and file playback is resumed. Next, processing of the ‘Info’ option is further detailed in connection with FIG. 11.

In FIG. 11, a selected moving image file is being played back on a screen 1110, as in the case of the screen 330 in FIG. 3. As described before in connection with FIG. 5, during playback of the file, a finger tap on a portion of the screen 1110 causes function bars 1121, 1122, and 1123 to be displayed as an overlay on the screen, as shown by a screen 1120. When a key of the function bar 1123 associated with the ‘Info’ option is selected by the user on the screen 1120, file information is displayed, as shown by a screen 1130. When the user issues a termination request for the ‘Info’ option (like ‘back’), the ‘Info’ option is terminated and file playback is resumed. At this time, the function bars 1121, 1122, and 1123 can also be displayed, as shown by a screen 1140.

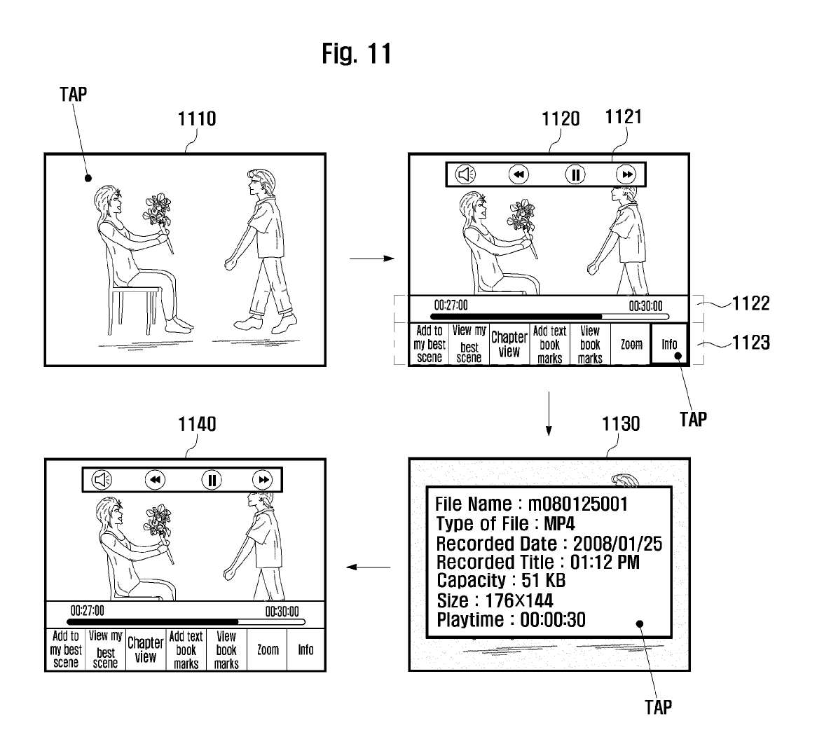

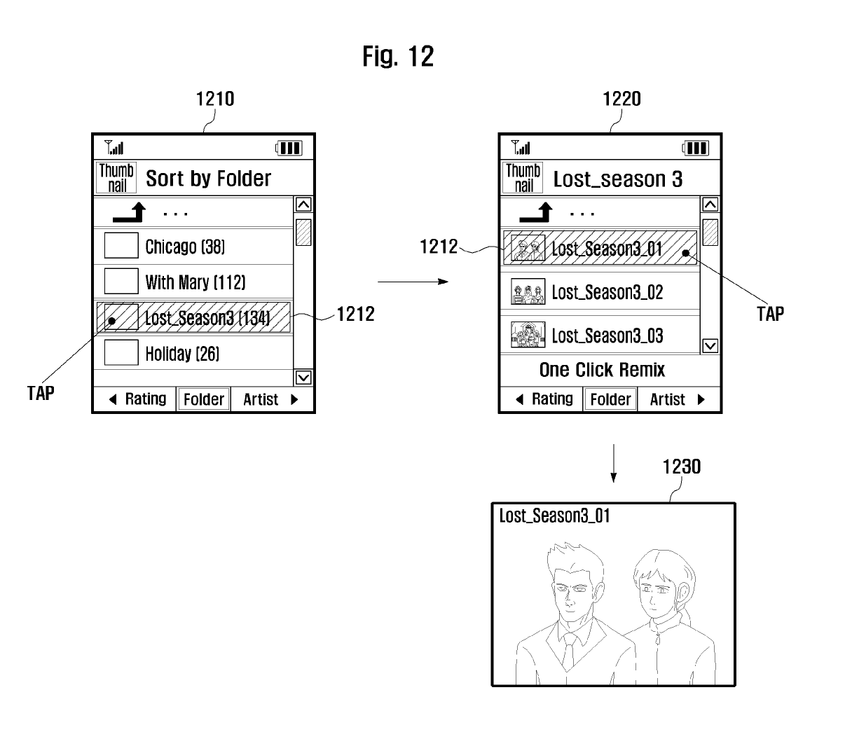

User option processing is described above during media file playback. Alternatively, a user option can also be processed while no media file is being played back. An example of user option processing without media file playback is described below in connection with FIG. 12.

FIG. 12 is additional screen representations related to processing of user options according to an exemplary embodiment of the present invention.

As shown by a screen 1210 in FIG. 12, a folder is selected and media files in the selected folder are listed. One of the listed media files can be selected according to user input. Here, a selection can be made by a finger tap on the touch screen including an input means. Selection of a file ‘Lost_Season3’ in the screen 1210 can cause images of the selected file to be listed for selection, as shown by a screen 1220. These images may be images added by the ‘Add to My Best Scene’ option or images associated with frames of segments demarcated by the ‘Chapter View’ option. When an image ‘Lost_Season3_01’ on the screen 1220 is selected by user input, a jump is made to the frame associated with the selected image and playback is initiated from the associated frame, as shown by a screen 1230.

As described above, exemplary embodiments of the present invention provide customizable user options for media file playback, satisfying various user needs and preferences. These customizable user options can be effectively used for developing and accessing user generated contents (UGC).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A playback method of a media file comprising multiple frames, the method comprising:
detecting a user option request;
selecting, in response to a user input, one frame of the multiple frames of the media file to process the detected user option request;
moving to the selected frame when the user option request requires a frame shift; and
playing back the media file from the selected frame in response to a playback request.

2. The playback method of claim 1, wherein detecting a user option request comprises detecting the user option request during play back of the media file, and
wherein the user option request is a request for one of user options related to preferred image addition, bookmark text insertion, preferred image viewing, bookmark text viewing, segmentation image viewing, image zooming in/out, file information viewing, thumbnail image changing, and image saving.

3. The playback method of claim 2, further comprising:
pausing playback of the media file in response to a request for the preferred image addition option and displaying images corresponding to a first frame being played at the time of receipt of the request for the preferred image addition option, to a second frame immediately before the first frame, and to a third frame immediately after the first frame;
adding, in response to selection of one of the displayed images, the selected image to a preferred image list and storing the preferred image list; and
resuming playback of the media file from the first frame in response to a resumption request.

4. The playback method of claim 2, further comprising:
pausing playback of the media file at a frame in response to a request for the bookmark text insertion option and entering into a text input mode;
receiving a text string;
exiting the text input mode after receiving the text string, inserting the text string into a bookmark list together with playback information of the paused frame, and storing the bookmark list; and
resuming playback of the media file from the paused frame in response to a resumption request.

5. The playback method of claim 2, wherein the user options for preferred image viewing, bookmark text viewing, and segmentation image viewing are options requiring the frame shift.

6. The playback method of claim 5, further comprising:
pausing playback of the media file in response to a request for the preferred image viewing option;
listing images of a stored preferred image list on a display section; and
displaying, in response to selection of one of the listed images, the selected image on the display section.

7. The playback method of claim 6, further comprising moving to a frame associated with the selected image and playing back the media file from the frame associated with the selected image in response to a playback request received after image selection.

8. The playback method of claim 6, further comprising enrolling the selected image as a thumbnail image of the media file in response to a thumbnail image change request.

9. The playback method of claim 6, further comprising storing the selected image in a storage unit in response to a save request.

10. The playback method of claim 5, further comprising:
listing texts of a bookmark list related to the media file in response to a request for the bookmark text viewing option; and
displaying, in response to selection of one of the listed texts, an image of a frame associated with the selected text.

11. The playback method of claim 5, further comprising:
pausing playback of the media file in response to a request for the segmentation image viewing option and demarcating the media file into segments of a fixed size;
listing images associated with beginning frames of the segments on a display section together with playback information; and
displaying, in response to selection of one of the listed images, the selected image.

12. The playback method of claim 2, further comprising enlarging or reducing an image displayed on a display section according to a zooming ratio in response to a request for the image zooming in/out option.

13. The playback method of claim 12, further comprising:
displaying, after image enlargement or reduction, an original image without enlargement or reduction on the display section; and
shifting the enlarged or reduced image according to a shift value input through the original image.

14. The playback method of claim 2, further comprising:
pausing playback of the media file at a frame in response to a request for the file information viewing option and displaying stored file information of the media file on a display section; and
resuming playback of the media file from the paused frame in response to a request to terminate the file information viewing option.

15. The playback method of claim 1, further comprising:
pausing playback of the media file at a frame in response to a request for an option not requiring the frame shift; and
resuming playback of the media file from the paused frame in response to a request to terminate the option.

16. The playback method of claim 1, further comprising displaying at least one of an option bar indicating a user option, an option bar indicating play time information of the media file, and an option bar indicating play control keys on a display section in response to a request received during playback of the media file.

17. A media file playback apparatus, comprising:
a storage unit to store at least one media file comprising multiple frames, and to store selected frames during processing of a user option;
an input section to receive a user input for a user option request and for selection of a frame or an image;
a display section to display an image associated with a frame, and to display a requested user option; and
a control unit to receive the user option request, to select, in response to a user input, one frame of the multiple frames of the media file to process the received user option request, to move to the selected frame when the user option request requires a frame shift, and to play back the media file from the selected frame in response to a playback request.

18. The media file playback apparatus of claim 17, wherein the user option request is a request for one of user options related to preferred image addition, bookmark text insertion, preferred image viewing, bookmark text viewing, segmentation image viewing, image zooming in/out, file information viewing, thumbnail image changing, and image saving.

19. The media file playback apparatus of claim 18, wherein when a user option request for the preferred image addition option is received during playback of a media file,
the display section displays images corresponding to a first frame being played at the time of receipt of the request for the preferred image addition option, to a second frame immediately before the first frame, and to a third frame immediately after the first frame,
the control unit pauses playback of the media file, selects one of the images displayed on the display section in response to a selection of one of the displayed images, adds the selected image to a preferred image list, and resumes playback of the media file from the first frame in response to a resumption request, and
the storage unit stores the preferred image list containing the added image.

20. The media file playback apparatus of claim 18, wherein when a user option request for the bookmark text insertion option is received during playback of a media file,
the control unit pauses playback of the media file at a frame, enters into a text input mode to receive a text string, exits the text input mode after receiving the text string, inserts the text string into a bookmark list together with playback information of the paused frame, and resumes playback of the media file from the paused frame in response to a resumption request,
the input section receives the text string during text input mode, and
the storage unit stores the bookmark list containing the received text string and playback information.

21. The media file playback apparatus of claim 18, wherein the user options for preferred image viewing, bookmark text viewing and segmentation image viewing are options requiring the frame shift.

22. The media file playback apparatus of claim 21, wherein when a user option request for the preferred image viewing option is received during playback of a media file,
the display section lists images of a stored preferred image list, and displays, in response to selection of one of the listed images, the selected image, and
the control unit selects a frame associated with the selected image.

23. The media file playback apparatus of claim 22, wherein the control unit moves to the selected frame and plays back the media file from the selected frame in response to a playback request received after image selection.

24. The media file playback apparatus of claim 22, wherein when a thumbnail image change request is received after image selection,
the display section displays a thumbnail image list,
the control units enrolls the selected image as a thumbnail image of the media file in the thumbnail image list, and
the storage unit stores the thumbnail image list containing the new thumbnail image.

25. The media file playback apparatus of claim 22, wherein when a save request is received after image selection, the storage unit stores the selected image.

26. The media file playback apparatus of claim 21, wherein when a user option request for the bookmark text viewing option is received during playback of a media file,
the display section lists texts of a bookmark list related to the media file, and displays, in response to selection of one of the listed texts, an image of a frame associated with the selected text.

27. The media file playback apparatus of claim 21, wherein when a user option request for the segmentation image viewing option is received during playback of a media file,
the control unit pauses playback of the media file, demarcates the media file into segments of a fixed size, selects a frame associated with a segment-related image selected using the display section, and
the display section lists images associated with beginning frames of the segments together with playback information, and displays, in response to selection of one of the listed images, the selected image.

28. The media file playback apparatus of claim 18, wherein when a user option request for the image zooming in/out option is received during playback of a media file,
the control unit enlarges or reduces a displayed image according to a zooming ratio, and
the display section displays the enlarged or reduced image.

29. The media file playback apparatus of claim 28, wherein
the display section displays, after image enlargement or reduction, an original image without enlargement or reduction, and displays, after shifting, a shifted image, and
the control unit shifts the enlarged or reduced image according to a shift value input through the original image.

30. The media file playback apparatus of claim 18, wherein when a user option request for the file information viewing option is received during playback of a media file,
the control unit pauses playback of the media file at a frame, and resumes, in response to a request to terminate the file information viewing option, playback of the media file from the paused frame, and
the display section displays stored file information of the media file.

31. The media file playback apparatus of claim 17, wherein during playback of a media file, the control unit pauses playback of the media file at a frame in response to a user option request not requiring the frame shift, and resumes playback of the media file from the paused frame in response to a request to terminate the option.

32. The media file playback apparatus of claim 17, wherein the display section displays at least one of an option bar indicating a user option, an option bar indicating play time information of the media file, and an option bar indicating play control keys in response to a request received during playback of the media file.

33. The media file playback apparatus of claim 17, wherein the input section comprises a touch sensor to detect a user touch on the display section, and the input section and display section constitute a touch screen.
